(19) United States
(12) Patent Application Publication
(10) Pub. No.: US 2016/0370210 A1
(43) Pub. Date: Dec. 22, 2016

(54) MODULAR FLEXIBLE SENSOR ARRAY

(71) Applicant: Amphenol Thermometrics, Inc., St. Marys, PA (US)

(72) Inventors: Christopher James Kapusta, Schenectady, NY (US); Aaron Jay Knobloch, Schenectady, NY (US); Jason Karp, Schenectady, NY (US)

(21) Appl. No.: 14/743,263

(22) Filed: Jun. 18, 2015

(51) Int. Cl. G01D 11/30

(52) U.S. Cl. CPC G01D 11/30

(57) ABSTRACT

The invention is directed to modular flexible sensor arrays that are adaptable, easy to manufacture, and which reduce material waste. A method of making a modular flexible sensor array is provided, including the steps of applying at least one sensing element to a first substrate to form at least one sensor, applying at least one electrically conductive interconnect to a surface of a second flexible substrate, and coupling the at least one sensor to the at least one electrically conductive interconnect such that the at least one sensor is electrically connected thereto.

### GOVERNMENT RIGHTS NOTICE

This invention was made with Government support under Award Number DE-AR0000269 awarded by U.S. Department of Energy. The Government has certain rights in this invention.

### FIELD OF THE INVENTION

The invention is directed to modular flexible sensor arrays and methods of making the same.

### BACKGROUND OF THE INVENTION

Flexible or “flex” sensor arrays are groupings of sensors formed on thin, flexible substrates. The use of flexible substrates is advantageous in a variety of applications where size and space are limited and electronic devices must be packaged as compactly as possible. Flex sensor arrays can be prepared with a variety of different types of sensors, including, but not limited to, temperature, strain, current, gas, and pressure sensors. For example, flex sensor arrays may be incorporated into medical catheters in order to measure pressure or temperature distributions within the human body.

A conventional flex sensor array is formed of a flexible non-conductive substrate (typically a dielectric material) having a specified length for a particular application. Electrical routing lines or “interconnects” extend along the length of the substrate and carry signals to and from the sensors and other connected electrical devices, such as electrical connectors or integrated circuits. The sensors are connected to the routing lines at various positions along the length of the flexible substrate in order to form an array having a specific geometry for a particular application.

Conventional flex sensor arrays are typically fabricated as one unitary body, whereby the routing lines and the sensors are formed using select types of metals that are applied directly to the flexible substrate. Routing lines are typically formed of aluminum or copper, while certain types of sensors, such as temperature and strain gage sensors, are often formed of expensive, precious metals (e.g., platinum). Other types of sensors can also be formed of silver or gold. Typically, the sensor is formed by sputtering or evaporating the precious metal(s) directly onto the substrate so as to not require a thermal processing step (most flexible substrates cannot withstand the high processing temperatures associated with other direct patterning processes). However, sputtering or evaporation application techniques require that the entire surface of the flexible substrate be covered in the precious metal, and then the excess metal is removed in the areas where it is not needed, leaving metal only in the areas where the sensor is to be located. This fabrication method results in a high amount of material waste and thus increases manufacturing costs since the sensor areas are a very small portion of the entire circuit. Additional processes are used to attempt to reclaim the wasted material. Moreover, forming flex sensor arrays with a variety of different types of sensors is time consuming, as each sensor must be individually formed separately on the substrate using separate processes. Additionally, because the flex circuit is formed as one unitary piece, the selection of suitable sensor material(s) is limited by the particular substrate and its processing parameters. Lastly, conventional manufacturing methods limit the ability to form complex sensor array configurations because intricate methods of removing the excess metal in fine spaces is required and some sensor metal types require different removal or etching techniques not commonly used in flex circuit fabrication.

Accordingly, methods of fabricating modular flex sensor arrays are needed that allow for the formation of sensor arrays having different types of sensors/materials and complex sensor configurations while reducing manufacturing costs and material waste.

### SUMMARY OF THE INVENTION

The invention provides a method of making a modular flexible sensor array comprising the steps of applying at least one sensing element to a first substrate to form at least one sensor, applying at least one electrically conductive interconnect to a surface of a second flexible substrate discrete from the first substrate, and attaching the at least one sensor to the at least one electrically conductive interconnect such that the sensor is electrically connected thereto.

The invention further provides modular flexible sensor array comprising a flexible substrate having at least one surface, a plurality of electrically conductive interconnects on the surface of the flexible substrate, each of the plurality of electrically conductive interconnects having at least one connection pad, and at least one discrete sensor attached to the at least one connection pad of the plurality of electrically conductive interconnects.

### BRIEF DESCRIPTION OF THE DRAWING

These and other features will be more readily understood from the following detailed description taken in conjunction with the accompanying drawings, in which:

FIG. 1 is a top view of a modular flex sensor array in accordance with an embodiment of the invention;

FIG. 2 is a top exploded view of the modular flex sensor array illustrated in FIG. 1;

FIG. 3 is a top view of a sensor in accordance with an embodiment of the invention;

FIG. 4 is a top view of a method of fabricating a plurality of sensors on a substrate in accordance with an embodiment of the invention;

FIG. 5 is a side elevational view of a sensor array in accordance with an embodiment of the invention;

FIG. 6 is a side elevational view of a sensor array in accordance with an embodiment of the invention;

FIG. 7 is a top view of a sensor array having alignment features in accordance with an embodiment of the invention;

FIGS. 8A-C are top views of modular flex sensor arrays in accordance with various embodiments of the invention; and

FIGS. 9A-B are side views of modular flex sensor arrays having coverlays in accordance with an embodiment of the invention.

### DETAILED DESCRIPTION

The invention is directed to modular flex sensor arrays and methods of manufacturing the same. The fabrication methods set forth herein allow for the sensors to be formed on a separate substrate from the flex substrate so as to minimize material waste and reduce manufacturing costs. The flex sensor arrays are modular such that any number and type of sensors can be formed on a separate substrate and then attached to the flex sensor array. Further, a wider variety of sensor types and configurations may be utilized because the formation of the sensor array is not dictated by the processing limitations of the flex substrate.

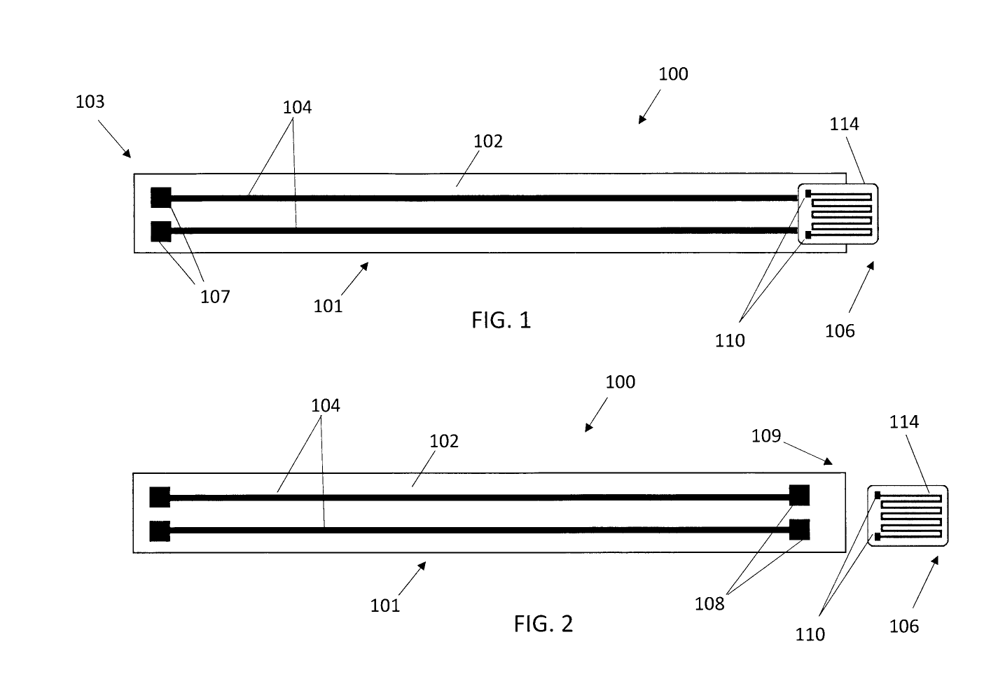

FIGS. 1 and 2 illustrate a modular flex sensor array 100 in accordance with an embodiment of the invention. The modular flex sensor array 100 is generally formed of an interconnect module 101 and one or more discrete sensing module or sensor 106. Where the modular flex sensor array 100 includes only one sensor 106, the term “array” is still used for purposes of this disclosure. The interconnect module 101 and sensor(s) 106 are separate and detached elements that can be made separately and attached together. The interconnect module 101 includes a flex substrate 102 that forms the spine of the interconnect module 101, and a plurality of routing lines or interconnects 104. The flex substrate 102 may be formed of any flexible, non-electrically conducting material suitable for use as a substrate for a sensor array. In one embodiment, the flex substrate 102 may be formed of polyimide (such as Upilex® or Kapton® films), polyester (such as Mylar® film), polyethylene terephthalate, or liquid crystal polymer. The flex substrate 102 may have any geometry suitable for use in a particular application, but it preferably has a thickness of less than 100 microns so as to remain sufficiently flexible and compact. In one embodiment, the flex substrate 102 may be formed of a plurality of layers of the same or different materials. The flex substrate 102 is preferably elongated such that it can accommodate a plurality of sensors 106.

The plurality of routing lines or interconnects 104 can be formed on or coupled to the flex substrate 102. For instance, the interconnects 104 are applied directly to an exposed surface of the flex substrate 102 and may be formed of any electrically conducting material compatible with the flex substrate 102 and suitable for carrying signals between the sensor(s) 106 and any other connected electrical devices. In one embodiment, the interconnects 104 are formed of aluminum or copper. The interconnects 104 may extend parallel to each other along the longitudinal axis of the flex substrate 102. In one embodiment, the interconnects 104 may be formed in pairs such that there are two interconnects 104 for each sensor 106 so as to apply a signal or current across each sensor 106. Depending on the number of sensors 106 and the preferred routing density, the interconnects 104 may be on both sides of the flex substrate 102, or even formed into a multilayer flex substrate 102 as discussed herein.

As shown in FIG. 2, each of the interconnects 104 may include at least one connection pad 108 at an end thereof for connecting the sensor(s) 106 to the interconnects 104. Specifically, the flex substrate 102 may have a first free end 103 that can be fitted with at least one first connection pad 107 to connect with other circuit elements. In one embodiment, the first free end 103 has two aligned connection pads 107. The flex substrate 102 may also have a second free end 109 opposite the first free end 103 having at least one second connection pad 108 to connect with the sensor(s) 106. In one embodiment, the second free end 109 has two aligned connection pads 108. In one embodiment, the connection pads 107, 108 may be formed of a metal for a solderable metal stack such as copper/nickel/gold alloy suitable for soldering thereto. The geometry of the connection pads 107, 108 is not particularly limited, as long as they have sufficient surface area to allow a sensor 106 to attach thereto. In another embodiment, the connection pads 107, 108 may be designed to be connected to an electrical connector, a ball grid array, or the like for specific applications.

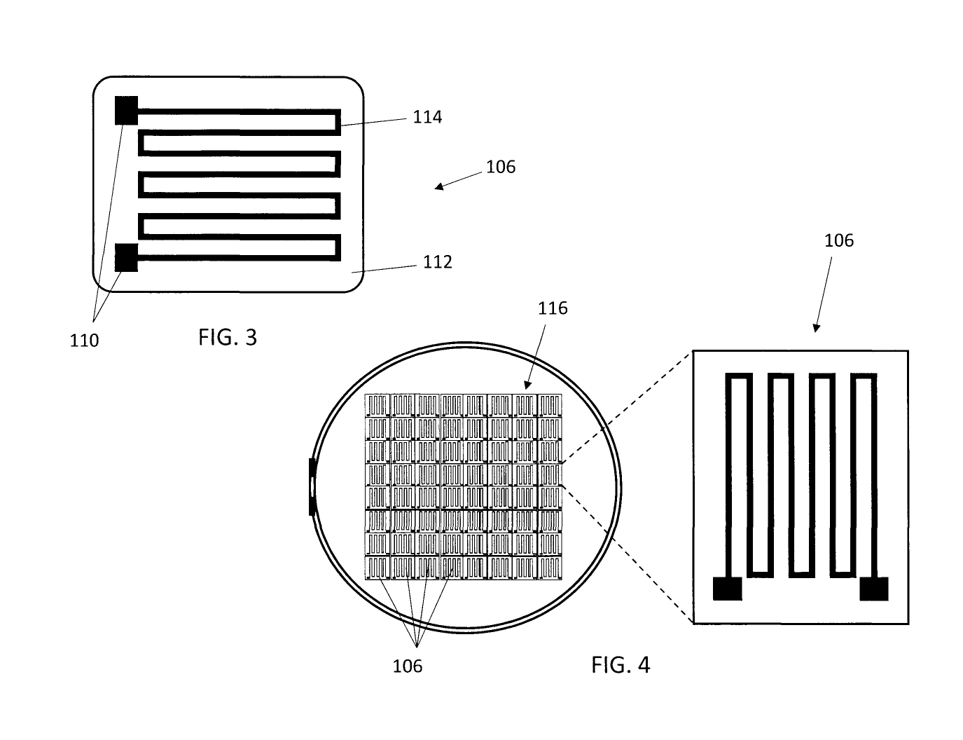

As best illustrated in FIG. 3, the discrete sensor 106 is generally formed of a sensor substrate 112 and a sensing element 114. In one embodiment, the sensor 106 further includes at least one connection pad 110. In a preferred embodiment, the sensor 106 has a first connection pad 110 at one end of the sensing element 114 and a second connection pad 110 at an opposite end of the sensing element 114. The substrate 112 may be formed of any material suitable for use in a particular sensor application, such as, for example, polyimide (such as Upilex® or Kapton® films), polyester (such as Mylar® film), polyethylene terephthalate, thinned silicon, glass, ceramic or FR-4 substrates, or liquid crystal polymer. In one embodiment, the substrate 112 has a thickness of about 100 microns or less, preferably about 25 microns or less, so as to be compatible with the flex substrate 102 while remaining flexible. The sensor 106 itself may be of any size and geometry; in one embodiment, the sensor 106 is about 5 mm in length and width. The sensing element 114 may be formed of any metal suitable for forming sensors, including, but not limited to, gold, silver, platinum, nickel, nickel-chromium alloys, and other precious metals or alloys. In at least one embodiment, the sensing element 114 is formed of platinum. The sensing element 114 pattern is not particularly limited and is determined by the type of sensor 106. In one embodiment, the sensing element 114 has a thickness of about 100 microns or less, preferably about 25 microns or less. The sensor 106 may be any type of sensor, such as, for example, a temperature, strain gage, eddy current, gas, or pressure sensor. In one embodiment, the sensor(s) 106 may include resistance temperature device (RTD) sensors. As set forth herein, the sensors 106 are discrete from the other components of the sensor array 100, including the interconnect module 101.

In one embodiment, the connection pads 110 are used to attach the sensors 106 to the interconnects 104 by electrically connecting the connection pads 110 to the connection pads 108 on the interconnects 104, as illustrated in FIG. 1. The connection pads 110 may be aligned with each other at one side of the sensor substrate 112. In this way, the pair of connection pads 110 may be aligned with the pair of connection pads 108 on the interconnects 104. Similar to connection pads 108, the connection pads 110 may be formed of a metal stack which enables the attachment of the sensor to the interconnect module 101. In one embodiment, a solderable metal stack up such as copper/nickel/gold alloy is used for soldering. However, in other embodiments, sensor(s) 106 and interconnect(s) 104 may be connected by means other than soldering, so the material of the connection pads 108 and 110 is not particularly limited.

One primary advantage of the present invention is that a plurality of sensors 106 may be manufactured separately from the interconnect module 101 and later attached thereto. Because a large number of sensors 106 can be formed together on one substrate and then separated (e.g., by cutting or dicing), they can be condensed into a small area which increases manufacturing efficiency and reduces material waste. Further, because various types of sensors 106 have differing tolerances and are made of different materials than interconnect module 101, separate processing of the sensors 106 allows them to not be dependent on the requisite parameters of the interconnect module 101. As illustrated in FIG. 4, a panel 116 comprising a plurality of sensors 106 may be formed using any methods known in the art. Specifically, the metal or alloy used to form the sensing elements 114 may be applied directly to the panel 116 by sputtering, evaporation or electroplating, and then the sensing element 114 metal is patterned using any known techniques, including laser ablation, shadow masks, or lift off techniques. The panel 116 is the same material as the sensor substrate 112. In this way, the plurality of sensing elements 114 are formed directly on the panel 116 and then each individual sensing element 114 and the underlying portion of the panel 116 is cut out to form discrete, separate sensors 106. The sensors 106 may then be incorporated into the sensor array 100 by attaching them to the interconnect module 101. The panel 116 illustrated in FIG. 4 is a single circular panel, but the panel 116 could also be formed as one square or rectangular elongated panel, or it could be formed using a roll-to-roll format to meet high volume production needs.

In one embodiment for forming an RTD sensor, a blanket coating of platinum may be sputtered onto a substrate, such as a Kapton® substrate. The platinum is then patterned using a laser ablation process, whereby a laser is rastered across the surface of the substrate with a pattern for the sensor such that the platinum is removed in certain areas. This laser process is optimized such that the localized heating which removes the platinum does not damage the underlying Kapton® substrate. The resistance may then be measured and the value compared to a target value for the RID sensor. The resistor (i.e., sensing element) is trimmed via the laser ablation process such that a target resistance may be achieved. The connection pads 110 may be formed via any known deposition process.

The attachment of the sensors 106 to the interconnect module 101 may be achieved by a variety of methods, including solder attachment as discussed above. In other embodiments, the sensors 106 may be attached to the interconnects 104 using conductive epoxy that acts as a glue, tape automated bonding (TAB), anisotropic conductive film (ACF) bonding, and anisotropic conductive paste (ACP) bonding. As depicted in FIG. 5, sensor 106 may be connected via a face-to-face attachment where the connection pad 110 on the sensor 106 makes direct contact with and engages the connection pad 108 on the interconnect 104. In this embodiment, the sensor 106 is inverted with respect to the interconnect module 101, such that the sensing element 114 faces the interconnect 104. The sensing element 114 is on the bottom of the sensor substrate 112 and faces downward, while the interconnect 104 is on the top of flex substrate 102 and faces upward. As such, conductive pads 108 and conductive pads 110 make direct contact.

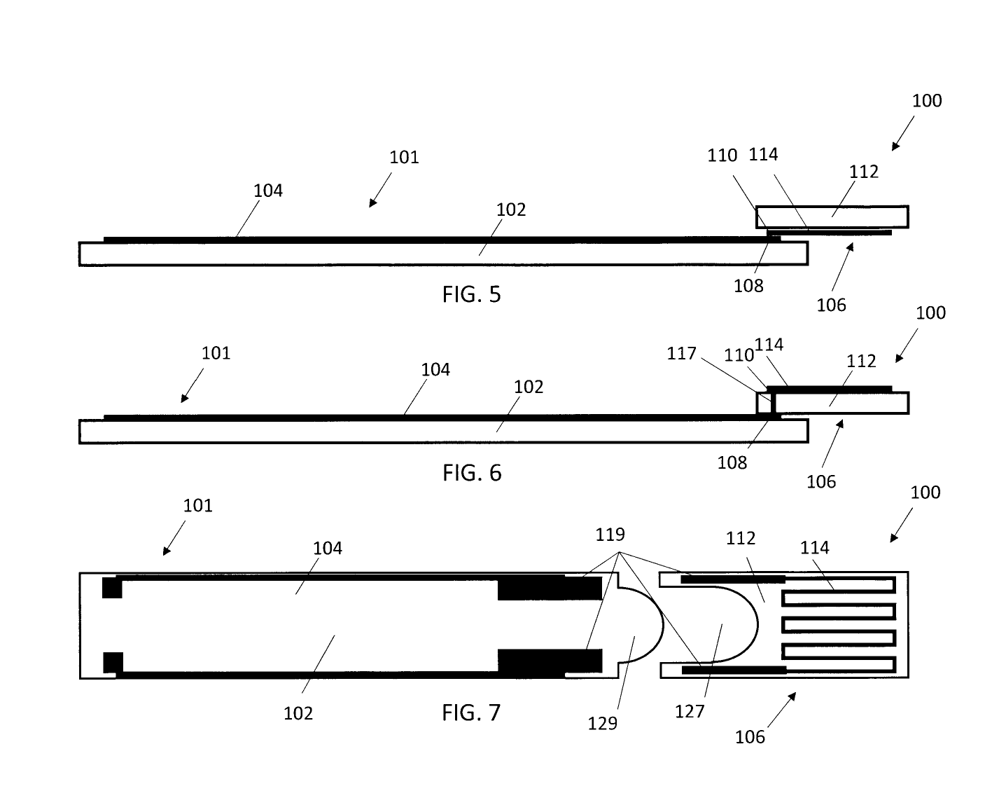

Alternatively, as shown in FIG. 6, sensor 106 may be connected by a through-via attachment, where the sensor substrate 112 makes direct contact with the interconnect 104 (or its connection pad 108) and the connection between the interconnect 104 and the sensing element 114 is made by extending a conductive via 117 entirely through the substrate 112. In this embodiment, the sensing element 114 is on the top of sensor substrate 112 and faces upward, while the interconnect 104 is on the top of flex substrate 102 and also faces upward. The conductive via 117 extends through the sensor substrate 112 from its top surface to its bottom surface. The conductive via 117 directly connects connection pad 110 to connection pad 108. In another embodiment, an additional connection pad (not shown) may be provided on the bottom of the sensor substrate 112 to connect with connection pad 108. In an alternative embodiment (not shown), the conductive via 117 could extend from the interconnect 104 through the flex substrate 102 to a sensor connection pad 110, such that the sensor 106 is contacting the opposite surface of the flex substrate 102 from the interconnects 104.

In another embodiment, as shown in FIG. 7, the interconnects 104 and sensor 106 may be formed with alignment features 127, 129 so as to ensure that direct electrical contact is made when the sensor 106 is attached to the interconnect 104 by providing lateral or angular alignment. In this embodiment, the alignment features 127, 129 are a groove and tab, respectively. Groove 127 is a semi-circular indentation formed in the sensor substrate 112. The tab 129 is a semi-circular extension formed in the flex substrate 102 and is designed to be received in groove 127. When tab 129 is received in groove 127, it ensures that the interconnect module 101 is aligned with the sensor 106. In this embodiment, enlarged connection pads 119 are illustrated. These pads have the same function as connection pads 108, 110 and extend along the top or bottom surfaces of the flex substrate 102 and sensor substrate 112.

The sensor array 100 may include a large number of sensors 106 connected along the flex substrate 102 spine in any variety of configurations and with different types of sensing elements 114. The resulting sensor array 100 is modular and adaptable and is easy to fabricate, thereby reducing manufacturing costs and material waste. In another embodiment, the sensor array 100 may include sensors 106 as well as other electrically connected components, including electrically erasable programmable read-only memory (EEPROM), thermistors, integrated circuits, pressure sensors, wireless antennas, and the like. Thus, the sensor array 100 can provide sensing functions and other electronic functions as well. The sensor array 100 also enables the integration of sensor manufacturing processes and materials that are not otherwise possible with conventional sensor arrays. Specifically, because the interconnect module 101 is formed separately from the sensor(s) 106, two separate and distinct manufacturing processes may be utilized which are otherwise incompatible if the interconnect module 101 and sensor(s) 106 were made on the same substrate. For example, the materials and manufacturing processes which are best suited for forming the interconnect module 101 may be utilized, while at the same time, the materials and manufacturing processes which are best suited for forming the sensor(s) 106 may be utilized, even where those materials and processes are incompatible. By way of example, a temperature sensor 106, which is formed with a combination of metal and an organic binder, can be incorporated together with printable or writeable sensors in the same array on a polymer flex substrate 101. A temperature sensor 106 can be formed directly on a ceramic substrate 112, for example, and then fired or sintered to remove the organic binder and leave the temperature sensitive metal behind (i.e., the sensor 106). Typically, such firing/sintering temperatures are in the range of 400-1,000° C., which is beyond the processing capabilities of a polymer substrate. In this way, a separate and discrete temperature sensor 106 can be formed on a ceramic substrate 112, while the flex substrate 102 can be separately formed from a polymer (e.g., Kapton®). When the temperature sensor 106 is connected to the interconnect module 101 formed of the polymer flex substrate 102, a sensor array 100 can be formed, particularly with other types of sensors 106, that integrates otherwise incompatible substrates and sensors. Accordingly, the sensor 106 can be made by a first process with a substrate 112 having a first material, and the interconnect module 101 can be made by a second process with a substrate 102 having a second material. The first and second processes can be different and/or discrete, and/or the first and second materials can be different and/or discrete.

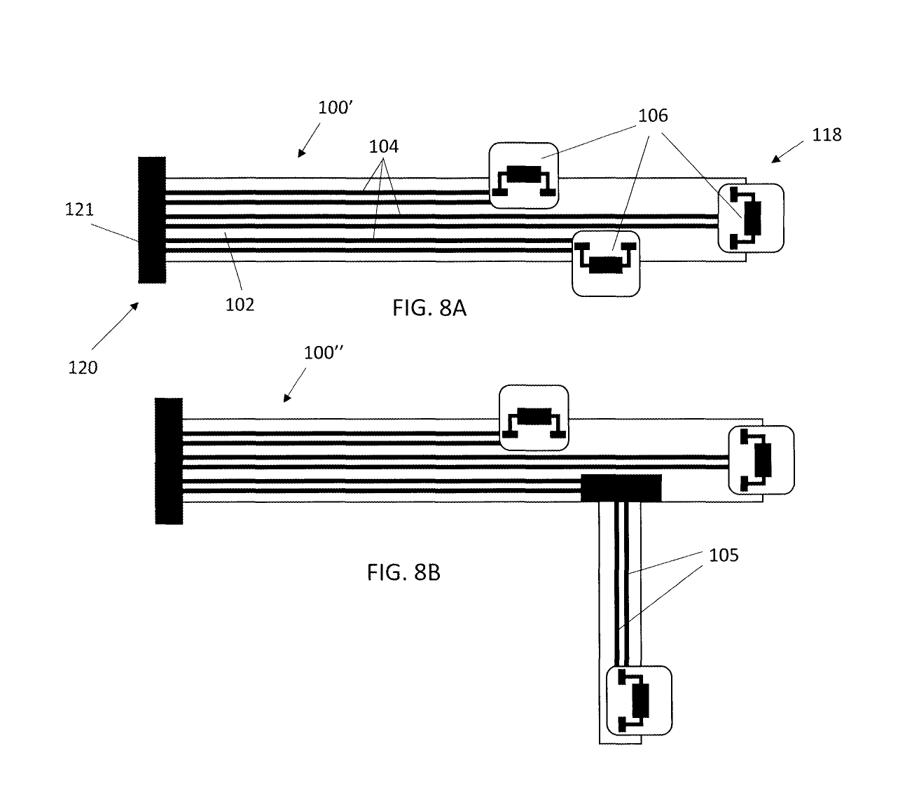

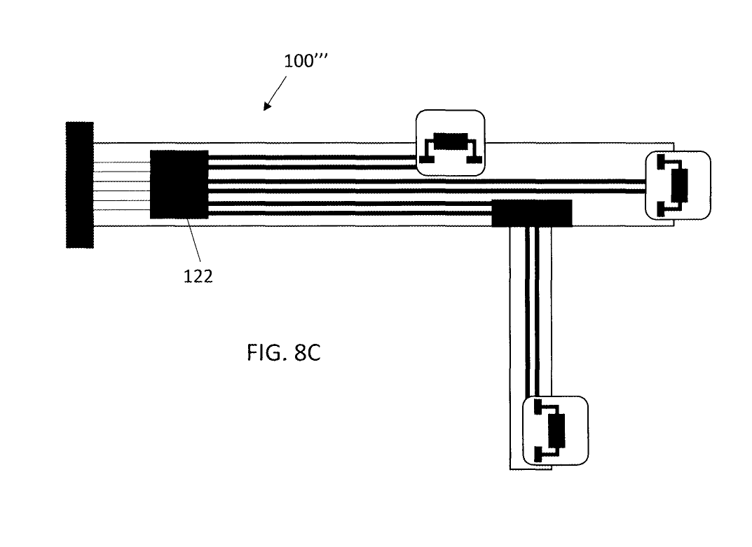

Exemplary sensor array configurations are set forth in FIGS. 8A-C. Sensor array 100′ includes three sensors 106 connected to interconnects 104 on each side of the substrate 102 and also at an end 118 of the array 100′. Opposing end 120 may include a connection or termination area 121, such as a connection to an electrical connector (not shown). Sensor array 100″ differs from sensor array 100′ in that one of the sensors 106 branches off from the first interconnects 104 via second interconnects 105 which forms a sensor “tree” array. Sensor array 100′″ has the same configuration as sensor array 100″, except that a circuit, an additional sensor, or other electronic element 122 may be incorporated into the array 100′″ via connection to the interconnect 104. In each embodiment configured in FIGS. 8A-C, the sensors 106 may be the same type of sensor or different types of sensors 106 depending on the particular needs of the application. The components of sensor arrays 100′-100′″ are enlarged in FIGS. 8A-C to more clearly illustrate their arrangement.

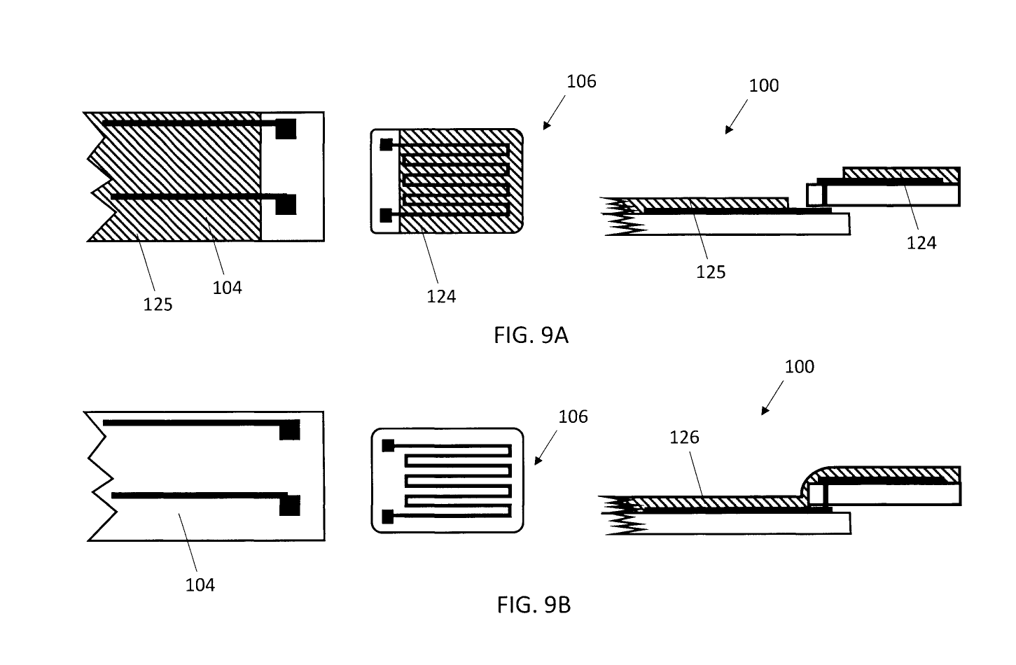

In another embodiment illustrated in FIGS. 9A-B, the sensor array 100 (or 100′, 100″, and 100′″) may include a coverlay to provide mechanical protection and electrical isolation to the various electrical components. The coverlay may be formed of a thin, flexible material such as polyimide film (e.g., Kapton® film), or it could be formed of the same material as the flex substrate 102 or sensor substrate 112. In one embodiment, a first coverlay 124 is provided over the exposed surface of the sensor 106, and a separate second coverlay 125 is provided over the exposed surface of the interconnects 104, as illustrated in FIG. 9A. The coverlay is not provided as one contiguous piece in this instance, but is formed as two separate pieces over each of the components. Accordingly, the coverlay 124 can be applied to the sensor 106 independently from the coverlay 125 applied to the interconnects 104. In this embodiment, the first coverlay 124 may be formed over the sensor 106 at the same time of the sensor fabrication while still on panel 116. Alternatively, as shown in FIG. 9B, coverlay 126 is provided as one uniform piece over the entire surface of the sensor array 100, such that the coverlay 126 is applied after the sensor 106 has already been connected to the interconnects 104. The thickness of the coverlay is preferably such that the overall thickness of the entire sensor array 100, including the coverlay, is still less than 100 microns. The coverlays 124-126 may be bonded to the substrate(s) 102, 112 via an adhesive layer, or they may be applied as a coating via spray or dip coating techniques using urethane or silicon-based materials.

The connections between the sensors 106 and the interconnect modules 101 in FIGS. 8A-C and FIGS. 9A-B, are preferably permanent electrical connections so as to prevent change in the resistance of the interconnect joint.

In the present disclosure, like-named components of the embodiments generally have similar features, and thus within a particular embodiment each feature of each like-named component is not necessarily fully elaborated upon.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method of making a modular flexible sensor array comprising the steps of:
applying at least one sensing element to a first substrate to form at least one sensor;
applying at least one electrically conductive interconnect to a surface of a second flexible substrate discrete from the first substrate; and
attaching the at least one sensor to the at least one electrically conductive interconnect such that the sensor is electrically connected thereto.

2. The method according to claim 1, wherein a plurality of sensing elements are formed on the first substrate, and the first substrate is then divided to separate each of the plurality of sensing elements to form a plurality of discrete sensors.

3. The method according to claim 1, wherein the at least one sensing element is formed of platinum.

4. The method according to claim 1, wherein the at least one sensor is at least one of a temperature sensor, strain gage sensor, eddy current sensor, gas sensor, or pressure sensor.

5. The method according to claim 1, wherein the first substrate and/or the second flexible substrate is formed of polyimide film, polyester film, polyethylene terephthalate film, or liquid crystal polymer.

6. The method according to claim 1, wherein the at least one electrically conductive interconnect is formed of aluminum or copper.

7. The method according to claim 1, wherein the at least one sensor is coupled to the at least one electrically conductive interconnect by solder, conductive epoxy, tape automated bonding (TAB), anisotropic conductive film (ACF) bonding, or anistropic conductive paste (ACP) bonding.

8. The method according to claim 1, wherein the at least one sensor and the at least one electrically conductive interconnect each have at least one connection pad.

9. The method according to claim 8, wherein the connection pad of the electrically conductive interconnect is directly engaged with the connection pad of the sensor.

10. The method according to claim 8, wherein the sensor is coupled to the connection pad of the electrically conductive interconnect by a through-via that extends from the sensing element of the sensor through the first substrate to the connection pad of the electrically conductive interconnect.

11. The method according to claim 10, wherein the at least one connection pad of the at least one sensor or the at least one electrically conductive interconnect is formed of copper/nickel/gold alloy.

12. The method according to claim 1, wherein the first substrate has a thickness of about 100 microns or less, preferably about 25 microns or less.

13. The method according to claim 1, wherein the at least one sensing element has a thickness of about 100 microns or less, preferably about 25 microns or less.

14. The method according to claim 1, wherein the step of applying at least one sensing element to a first substrate is done by sputtering, evaporation or electroplating.

15. The method according to claim 1, wherein the at least one electrically conductive interconnect has an alignment mechanism that engages with an alignment mechanism on the at least one sensor.

16. The method according to claim 1, the modular flexible sensor array includes electrically erasable programmable read-only memory, at least one thermistor, at least one integrated circuit, at least one wireless antenna, or a combination thereof.

17. The method according to claim 1, further comprising the step of applying a uniform coverlay over a surface of the sensor array after the at least one sensor is attached to the at least one electrically conductive interconnect.

18. The method according to claim 1, further comprising the steps of:
applying a first coverlay over a surface of the at least one electrically conductive interconnect; and
applying a second coverlay over a surface of the at least one sensor.

19. The method according to claim 18, wherein the steps of applying a first coverlay and a second coverlay may be done by dip coating or spray coating.

20. The method according to claim 1, wherein the at least one sensing element is formed by a first process and the at least one electrically conductive interconnect is formed by a second process discrete from the first process.

21. A modular flexible sensor array comprising:
a flexible substrate having at least one surface;
a plurality of electrically conductive interconnects on the surface of the flexible substrate, each of the plurality of electrically conductive interconnects having at least one connection pad; and
at least one discrete sensor attached to the at least one connection pad of the plurality of electrically conductive interconnects.

22. The modular flexible sensor array of claim 21, wherein the at least one discrete sensor comprises a substrate and a sensing element.

23. The modular flexible sensor array of claim 22, wherein the sensing element is provided on a bottom side of the substrate and wherein the sensing element faces and is directly attached to the at least one connection pad of the electrically conductive interconnects.

24. The modular flexible sensor array of claim 22, wherein the sensing element is provided on a top side of the substrate and a bottom side of the substrate makes contact with the at least one connection pad of the electrically conductive interconnects, such that the sensing element is directly connected to the at least one connection pad of the electrically conductive interconnects by a through via that extends from the top side of the substrate to the bottom side of the substrate.

25. The modular flexible sensor array of claim 21, comprising a plurality of discrete sensors, wherein the sensors are temperature, strain gage, eddy current, gas, RTD, or pressure sensors, or combinations thereof.

26. The modular flexible sensor array of claim 21, wherein the modular flexible sensor array may be physically deformed and then return to its original shape when in use.

27. The modular flexible sensor array of claim 21, wherein the modular flexible sensor array may be physically deformed to conform to the shape of a device being measured.
